(19) United States
(12) Patent Application Publication
(10) Pub. No.: US 2005/0097002 A1
(43) Pub. Date: May 5, 2005

(54) Present giving system, present giving server system, present giving program, and present giving method

(75) Inventor: Shinichi Araki, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 10/951,657

(22) Filed: Sep. 29, 2004

(30) Foreign Application Priority Data
Oct. 31, 2003 (JP) 2003-373563
Aug. 6, 2004 (JP) 2004-231580

(51) Int. Cl. G06F 17/60

(52) U.S. Cl. 705/26

(57) ABSTRACT

A present giving system gives a present corresponding to a category within an estimated cost on an occasion for presents and allows a present receiver to accept or reject the present selected by a present sender. A server conducting the electronic commercial transaction requests input of information of a date, information uniquely specifying a second client device, and selection items associated with the date information from a first client device, and reminds the first client device of an the date and details of the selection items associated with the date information at a proper date and time before the input date. Then, the server device notifies the second client device of the selected items in accordance with the selected items selected by the first client, notifies the first client device of an item selected by the second client device, and allows the first client device to determine acceptance and rejection of the selected item.

The present disclosure relates to subject matter contained in Japanese Patent Application No. 2004-231580, filed on Aug. 6, 2004 and Japanese Patent Application No. 2003-373563, filed on Oct. 31, 2003, the disclosures of which are expressly incorporated herein by reference in their entirety.

### BACKGROUND OF THE INVENTION

1. Field of the Invention

The present invention relates to a present giving system, a present giving server system, a present giving program, and a present giving method, in which a user accessing a network with a communication terminal such as a mobile phone, which can be connected to the network, can access a server system for providing a present giving service and give a present on special occasions such as an anniversary.

2. Description of the Related Art

Constant access to communication networks such as the Internet, etc. with advancement of technologies such as ADSL, FTTH, etc. and the spread thereof to general homes has occurred, and mobile phones can now access Internet sites similarly to fixed communication terminals by means of easy access via the mobile phones to communication networks due to the advancement and spread of protocol technologies such as cHTML or WAP. Recently, web pages corresponding to the mobile phones have increased in Web sites employing the web pages (Http protocols), so that the Web sites could be easily accessed and the market has become active.

By solving a technical problem such as security, etc., electronic commercial transactions have been employed in the Web sites, and users could access the Web sites for the electronic commercial transaction with communication terminals such as the mobile phones and personal computers and could purchase products and services electronically.

In the electronic commercial transaction carried out over the Internet, the users access electronic cyber malls over Internet with the communication terminals such as the mobile phones and personal computers, selects products provided in sites of the cyber malls, and input attribute information of product destinations, etc. and attribute information of billing destinations, etc.

In general, in a Web site for conducting the electronic commercial transaction, an internal server, etc. running the Web site comprises a database and member register information received from the users through a member registration page, etc. in the database. At the time of sending products and billings, by retrieving the database data using a membership number, etc. as key information, acquiring sender information and billing destination information from the database, and automatically reflecting the retrieved information to screen information of a web page, reduction of input operations by a user could be achieved.

In such an electronic commercial transaction site, as disclosed in JP-A-2002-216006, a method of notifying or reminding a user of an arrival of particular days or special occasions such as an anniversary, etc., which it is difficult for the user to memorize but which is important, and information of products suitable for the particular days is known. In this case, the user should previously register dates of the particular days and details of the particular days or occasions in a server device for providing the services over networks. The server device notifies the user of the arrival of the particular days without fail and also provides information (URL, etc.) on the electronic commercial transaction sites of the service providers. In this way, according to the above-mentioned system, the user can purchase presents, etc. from the electronic commercial transaction sites of the service providers.

In the conventional method, since a present sender could not reject a present selected by a present receiver, situations occurred where undesired present was sent. At this time, in a case where a present recipient is a person such as a son or a grandson to be taken care of by the present sender, the service quality provided to a user is not so good, so that it is difficult to use the existing electronic commercial transaction system for giving a present.

Further, since information on categories or estimated cost of presents is not registered in the server in the conventional electronic commercial transaction, the service providers are entrusted with providing information of products to be provided and it is not possible to provide the present information including product categories and products within estimated cost ranges desired by the present sender from the server.

### SUMMARY OF THE INVENTION

The present invention is provided in view of the conventional disadvantages described above, and it is an object of the present invention to provide a present giving system, a present giving server system, a present giving program, and a present giving method, in which when e.g. an anniversary on which a presentation must be provided comes near, a present can be sent to a present recipient without fail by notifying a user of an arrival notice message using an electronic mail address or a unique account name, it is possible to send a present within a category and at estimated cost, and a present sender can reject the present selected by a present receiver.

According to a first aspect of the present invention, a present giving system includes first and second client devices which are used by users and can communicate with a server system through networks. The server system is capable of communicating with the first and second client devices through the networks, the server system including an input for receiving and storing information of a date related to a user, information uniquely specifying a user of the second client device, and information of selection items associated with the date information from the first client device. A preliminary notifier notifies the first client device of an approach of the date and details of the selection items associated with the date information at a predetermined notice date and time before the input date. A notifier notifies the second client device of present candidates based on the selection items transmitted from the first client device based on the notice. An acceptance-rejection determiner notifies the first client device of information of a selected present transmitted from the second client device and allows the first client device to accept or reject the present selected by the second client device.

Another aspect of the present application relates to a present giving server system capable of communicating with first and second client devices used by users through networks the server system includes: an input receives and stores information of a date related a user, information uniquely specifying a user of the second client device, and information of selection items associated with the date information from the first client device. A preliminary notifier notifies the first client device of an approach of the date and details of the selection items associated with the date information at a predetermined notice date and time before the input date. A notifier notifies the second client device of present candidates based on the selection items transmitted from the first client device based on the notice. An acceptance-rejection determiner that notifies the first client device of information of a selected present transmitted from the second client device and allows the first client device to accept or reject the present selected by the second client device.

Further, the date information can be an anniversary of a present recipient, and the selection items associated with the date information includes an estimated cost for a product to be presented and a category of presents. Additionally, the information uniquely specifying a user of the second client device can be an electronic mail address.

Yet further, the information uniquely specifying a user of the second client device can be an account name unique to a member of a present giving system, and a message can be electronically transmitted in association with the account name. Plural presents can be selected within the estimated cost. The notice date and time can be set by the first client device. The first client device can input a message about the user of the second client device on the basis of the notification from the preliminary notifier, and the notifier notifies the second client device of the message input by the first client device

Additionally, the notifier uses an URL as a pointer indicating a source of the information associated with the present candidates, sets an access restriction to the reading of the notified URL, and notifies the second client device of a message. When the selected present information transmitted from the second client device is rejected by the first client device, the acceptance-rejection determiner deletes the rejected present from the present candidates and allows the notifier to again notify the second client device of the remaining present candidates. Further, the acceptance-rejection determiner enables the first client device to input a message about the user of the second client device, and the notifier notifies the second client device the message input by the first client device

A further aspect of the present invention relates to a present giving program allowing a computer of a server system, which can communicate with first and second client devices used by users through networks, to operate. The program provides an input for receiving and storing information of a date related to a user, information uniquely specifying a user of the second client device, and information of selection items associated with the date information from the first client device. The program also provides a preliminary notifier for notifying the first client device of an approach of the date and details of the selection items associated with the date information at a predetermined notice date and time before the input date. The program further provides a notifier for notifying the second client device of present candidates based on the selection items transmitted from the first client device based on the notice. The program additionally provides an acceptance-rejection determiner for notifying the first client device of information of a selected present transmitted from the second client device and allowing the first client device to accept or reject the present selected by the second client device.

A further aspect of the present invention relates to a present giving method, which includes: Inputting, by a first client device, information of a date related to a user, information uniquely specifying a user of a second client device, and information of selection items associated with the date information to a server system and storing the input information in the server system. The method further includes notifying, by the server system, the first client device of an approach of the date and details of the selection items associated with the date information at a predetermined notice date and time before the input date. The second client device of present candidates based on the selection items transmitted from the first client device based on the notice, and the first client device of information of a selected present transmitted from the second client device and allowing the first client device to accept or reject the present selected by the second client device.

### BRIEF DESCRIPTION OF THE DRAWINGS

FIG. 1 is a structural diagram of a present giving system according to the present invention;

FIG. 2 is a block diagram of a server according to the present invention;

FIG. 3 is a block diagram of a client device according to the present invention;

FIG. 4 is a flowchart illustrating a continuation of the processing sequence of the present giving system according to the present invention;

FIG. 5 is a flowchart illustrating a continuation of the processing sequence of the present giving system according to the present invention;

FIG. 6 is a flowchart illustrating a continuation of the processing sequence of the present giving system according to the present invention;

FIG. 7 is a flowchart illustrating a continuation of the processing sequence of the present giving system according to the present invention;

FIG. 8 is a flowchart illustrating a continuation of the processing sequence of the present giving system according to the present invention;

FIG. 9 is a flowchart illustrating a continuation of the processing sequence of the present giving system according to the present invention;

FIG. 10 is a flowchart illustrating a continuation of the processing sequence of the present giving system according to the present invention;

FIG. 11 is a flowchart illustrating a continuation of the processing sequence of the present giving system according to the present invention;

FIG. 12 is a flowchart illustrating a processing sequence of the present giving system according to the present invention;

FIG. 13 illustrates screens of a first client device of the present giving system according to the present invention;

FIG. 14 illustrates further screens of the first client device of the present giving system according to the present invention;

FIG. 15 illustrates screens of the first client device of the present giving system according to the present invention;

FIG. 16 illustrates a further screen of the first client device of the present giving system according to the present invention; and

FIG. 17 illustrates screens of a second client device of the present giving system according to the present invention.

### DESCRIPTION OF THE PREFERRED EMBODIMENTS

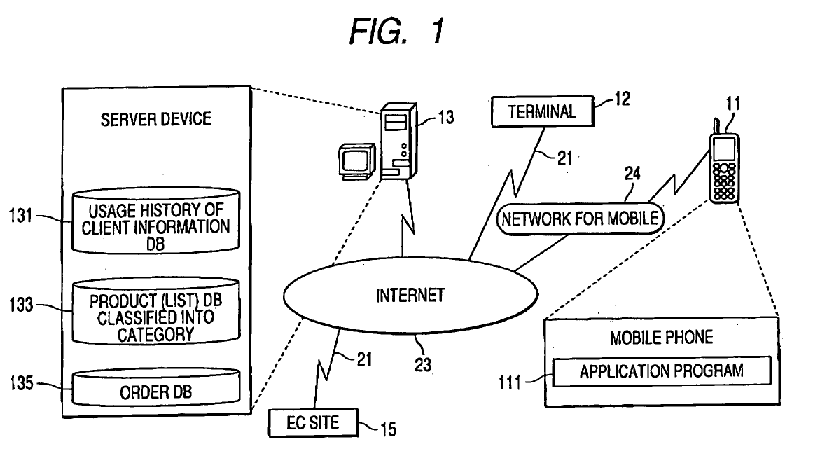

Hereinafter, an example of a best mode for putting the present invention into practice will be described in detail with reference to the accompanying drawings. First, the entire structure of the present invention will be described with reference to FIG. 1. FIG. 1 is a structural diagram of a present giving system according to the present invention.

A server device 13 and an electronic commercial transaction (EC) site 15 can be mutually connected through a network such as the Internet 23 and a communication line 21 (wired or wireless), can be connected to a terminal 12 such as a personal computer, PDA, etc. which is a kind of client device, and can communicate with a mobile phone 11, which is a kind of client device, through a network for mobile phones 24 connected to Internet 23.

A user accesses Internet 23 in accordance with the respective protocols through the network for mobile phones 24 or the communication line 21 (for example, ADSL, FTTH, wireless, etc.) with the mobile phone 11 or the terminal 12 which serves as an example of client device. The mobile phone 11 and the terminal 12 include a mail transmitting and receiving program and a web browser program, or include an application program 111 for the electronic commercial transaction system having the functions of the programs.

In this embodiment, the server device 13 and the electronic commercial transaction site 15 provide a service such as a present giving server system, where the functions of as a front end to a user is assigned to the electronic commercial transaction site 15 and the function of a back end having a database is assigned to the server device 13. However, the present invention may be constructed such that the server device 13 has all the functions of the electronic commercial transaction site 15. In this specification, one or more server devices for performing the functions of the server device 13 and the electronic commercial transaction site 15 can be utilized and constitute a server system.

The server device 13 includes a client information (or usage history) database 131 for storing attribute information of a user to participate in the electronic commercial transaction such as an address, a name, a phone number, an electronic mail address, a member ID of a present giving system, a payment method, payment card information, a bank account, etc. and his usage history. A product database 133 contains attribute information of products such as prices of products, customers of products, etc. and the products are classified into categories and can be registered, referred to, and corrected. An order treatment database 135 is used until an order treatment is completed after the order treatment is started is also provided in the server 13.

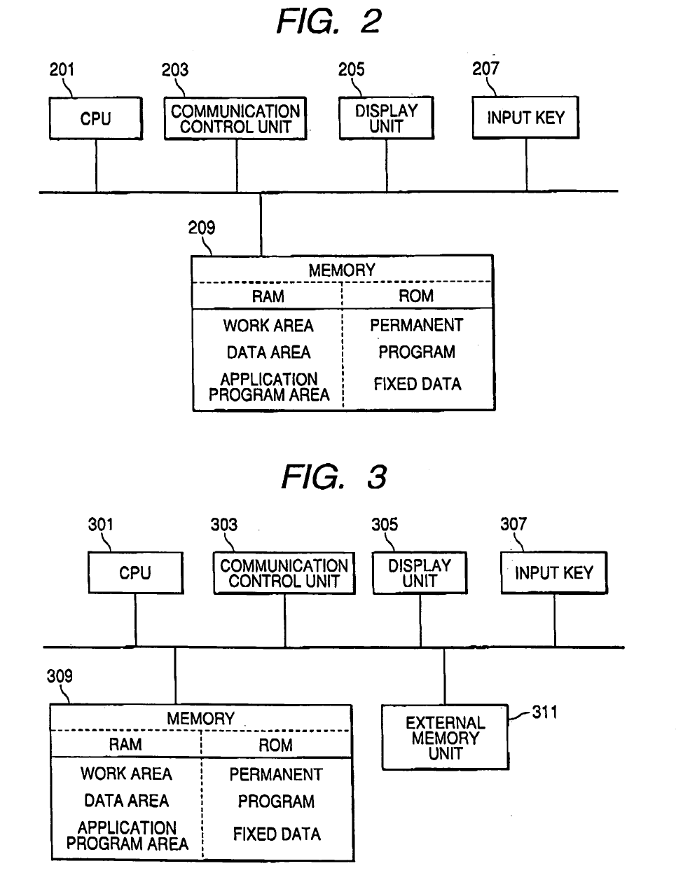

FIG. 2 is a block diagram illustrating a structure of the mobile phone 11 which is an example of client device according to the present invention. The mobile phone 11 comprises a CPU 201 serving as a central processing unit, a communication control unit 203 for performing communication with a base station of the network for mobile phones 24, a display unit 205 having, for example, a liquid crystal display device, an input keypad 207 such as a ten key, an auxiliary key, a function key, etc. and/or another input device and a read-only and readable-writable memory 209. The readable-writable memory of the memory 209 is used, for example, as a space for an area of a program programmed in e.g. the Java (registered trademark) language, etc. and downloaded from a Web site, and the read only memory stores, for example, an operating system program, a web browser program, a mail transmitting and receiving program, etc. which are for example Java (registered trademark) application programs. Although not shown, a voice processing unit is provided therein.

FIG. 3 is a block diagram illustrating a structure of the server device or server 13 according to the present invention. The server device 13 comprises a CPU 301, a communication control unit 303 for performing communication with Internet 23 through a router, etc., a display unit 305, an input and output unit 307, an external memory unit 311 including a hard disk, etc., and a read-only and readable-writable memory 309.

A user accesses the electronic commercial transaction site 15 over Internet through the communication line 21 with, for example, the web browser of a client device, when utilizing the electronic commercial transaction site 15.

The electronic commercial transaction site 15 transmits information requesting input of a member ID to a first client device that has accessed the site. When the user is a member, the user inputs and transmits his/her member ID, and when the user is not a member, the user presses a new member-registering button.

The electronic commercial transaction site 15 determines whether the user having accessed the site with the member ID is a member or not, transmits registered-detail information of a registered present destination when it has been determined that the user is a member, and transmits information of a new member registering screen when it has been determined that the user is not a member.

In a case of registering a new member, the electronic commercial transaction site 15 or the server device 13 transmits a screen for inputting an address, a name, a phone number, an electronic mail address, a payment method, payment card information, etc. of a user as member information and then transmits a present-destination registration screen to the first client device.

The present registering screen can be repeatedly provided until the user completes the number of necessary registrations. In the present registering screen, an address, a name, a phone number, an electronic mail address, etc. of a present recipient to who a present would be sent, an anniversary on which a present must be provided, estimated cost for the present, a category of presents, a message, etc can be registered i.e. stored, and the anniversary on which a present must be provided, the estimated cost, the category, and the message can be registered for a plurality of persons, dates, presents, etc.

When accessed by an existing member, the electronic commercial transaction site 15 or the server device 13 transmits the screens for member information and present information in a structure in which the screens can be added, corrected, and deleted. The user can add, correct, and delete his/her attribute information necessary for participating in the electronic commercial transaction such as his/her name, address, etc. and the present destination information in the screen, and transmits the information to the electronic commercial transaction site 15 when the information has been added, corrected, and deleted. The electronic commercial transaction site 15 updates the client information DB 131 by notifying the server device 13 of the updated information from the first client device.

The server device 13 retrieves the client information DB 131 and lists the registered information in which the registered anniversary is determined to approach. The retrieval interval can be specified, for example, such that the retrieval should be carried out for example once a day at 0 O'clock, etc.

The determination that the anniversary approaches can be carried out, for example, one week before the anniversary, which is set in advance in the server device 13, or on an arrival notice date (for example, two week before October 24) which is specified by the user at the time of registering the present destination.

A list corresponding to the estimated cost and the category of presents set or stored in the listed registration information is prepared for every user. Then, a URL, an access restriction, a password are set to each list, and a message is previously input thereto. The message to be sent on the anniversary, the URL of the prepared list, and the password for accessing the URL are transmitted to a present recipient using an electronic mail or a message with a member ID when the counter part i.e. present recipient is also a member and thus the transmission and reception of a message can be performed with the member ID.

The message receiver can view the message of a present sender and the selection information of presents, can select a desired product, and can transmit a message to the present sender, by accessing the URL with the password.

The present can be selected a number of times within the estimated cost for each category, and products that can be selected next within the estimated cost may be rearranged and displayed on a screen, whenever one present is selected. The present receiver can select a present and can transmit a message to the user of the first mobile phone 11 of the present sender.

The present details and message selected by the the present receiver are notified to the present sender through the electronic commercial transaction site 15. The present sender can reject the details of the present selected by the user of the present receiver through the electronic commercial transaction site 15.

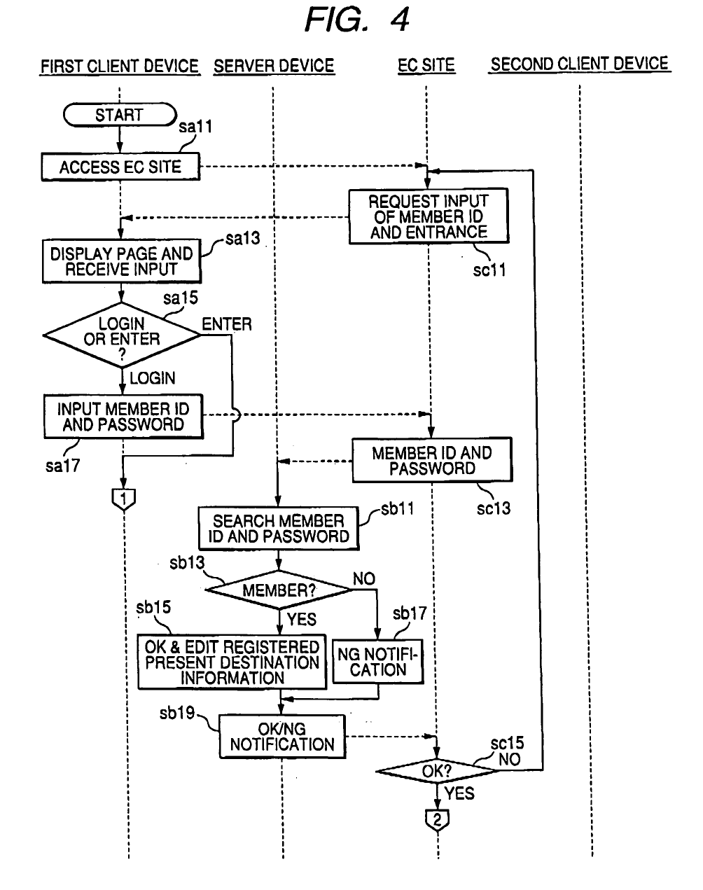

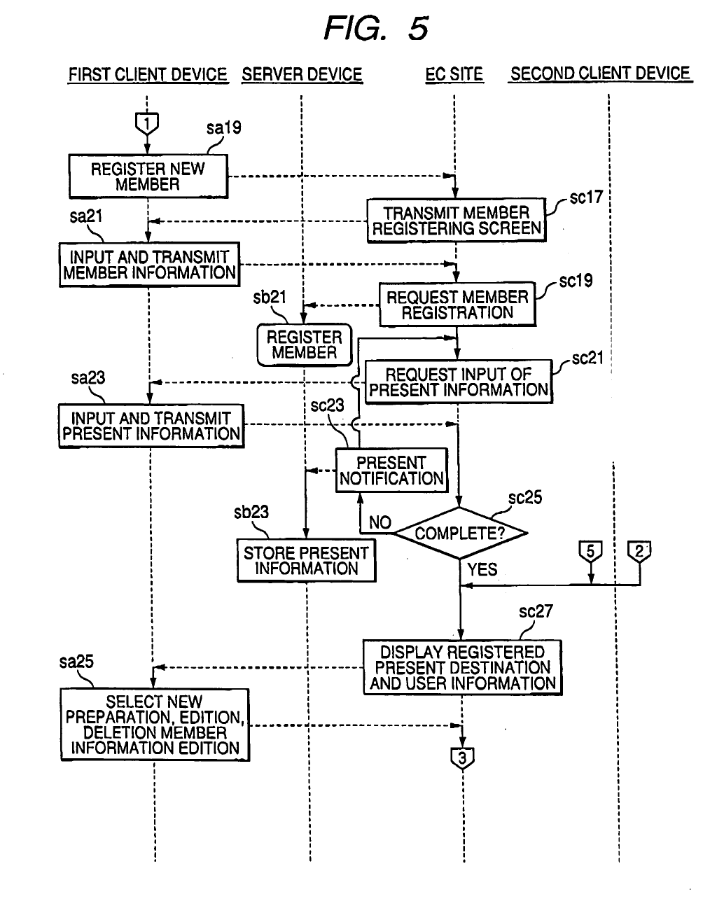

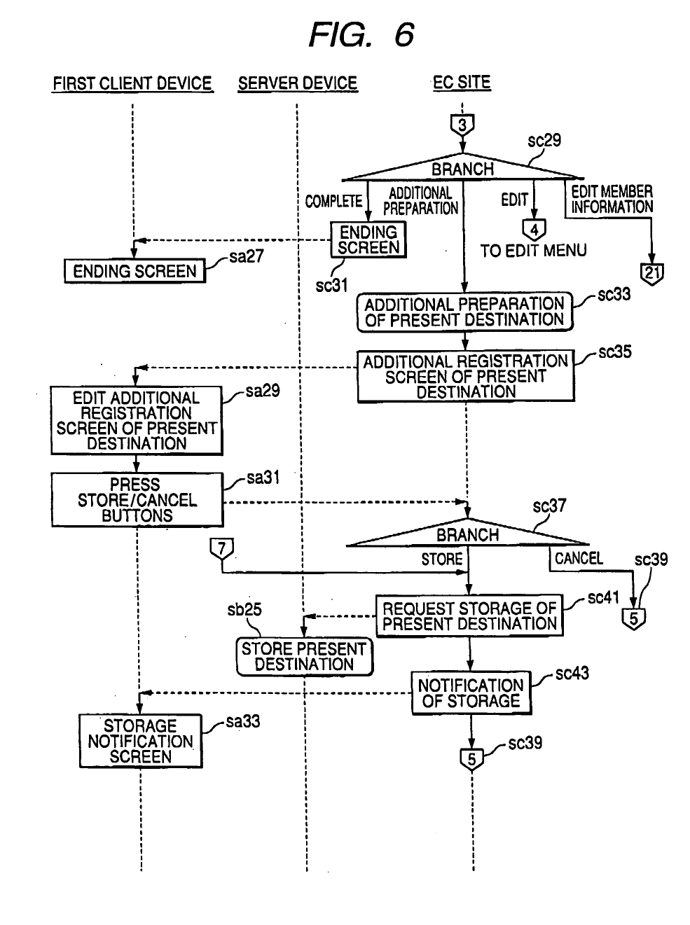

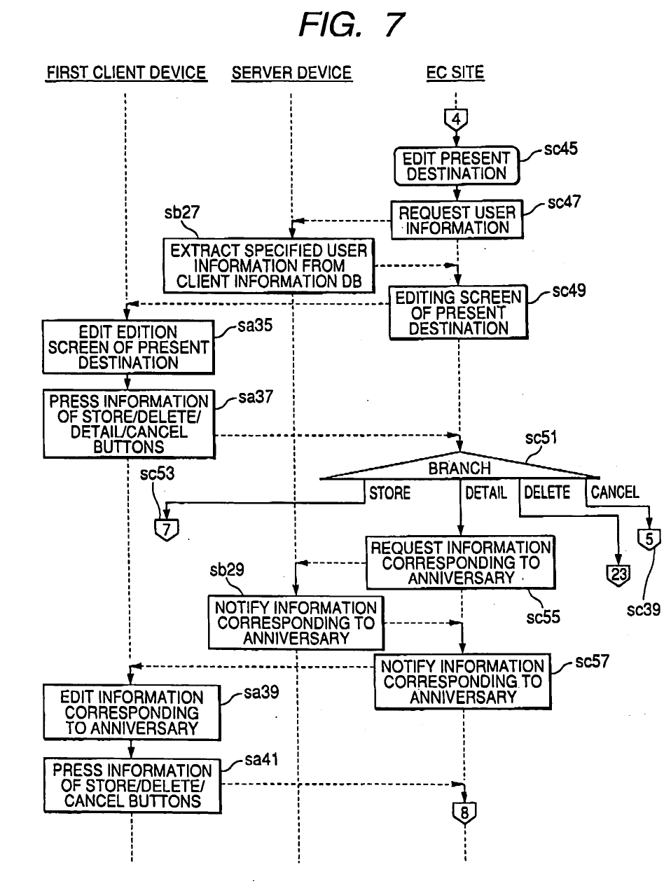

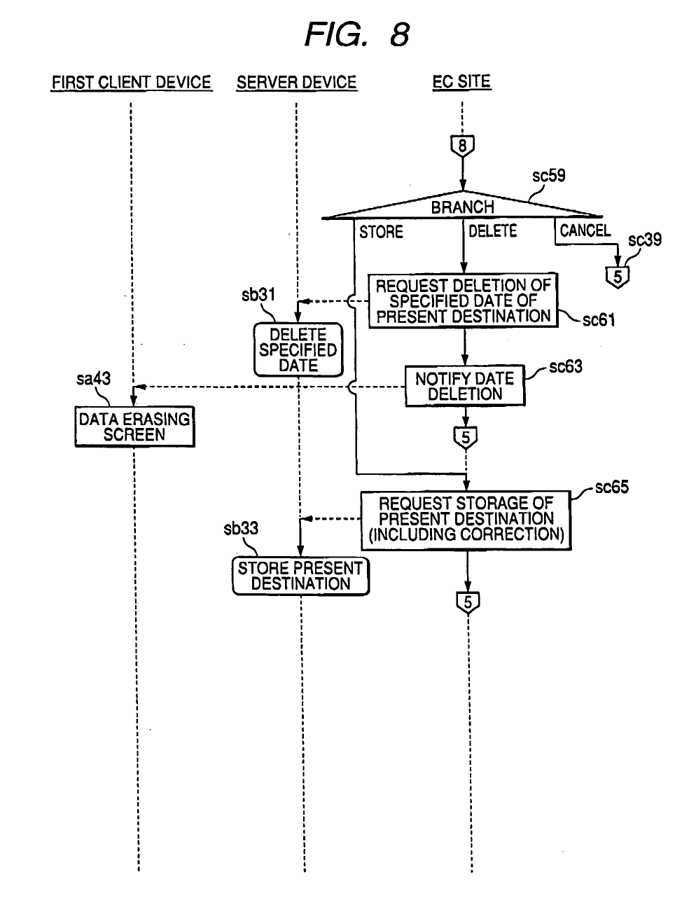

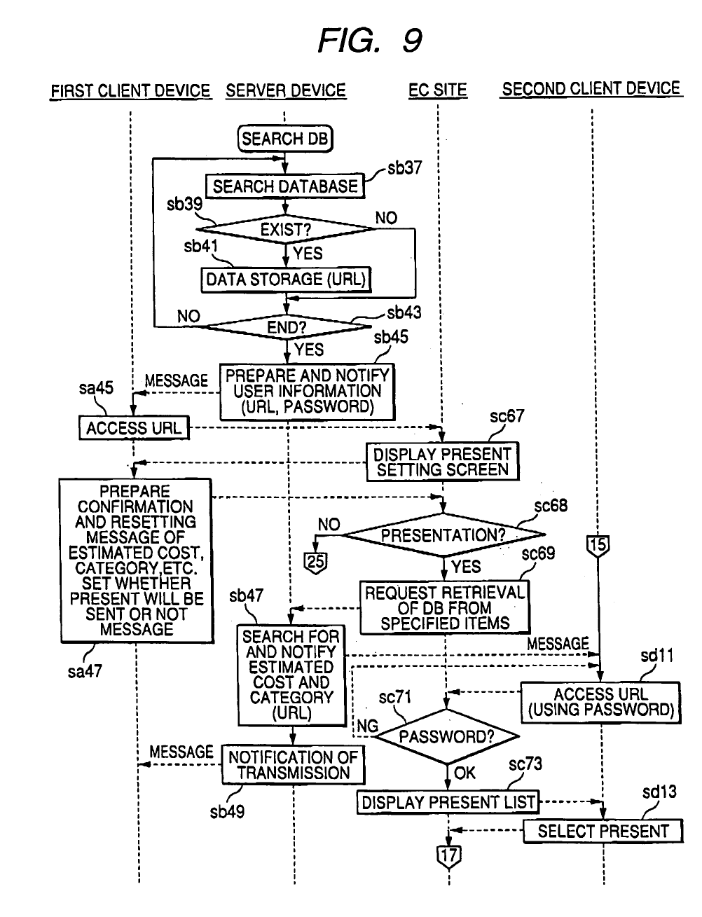

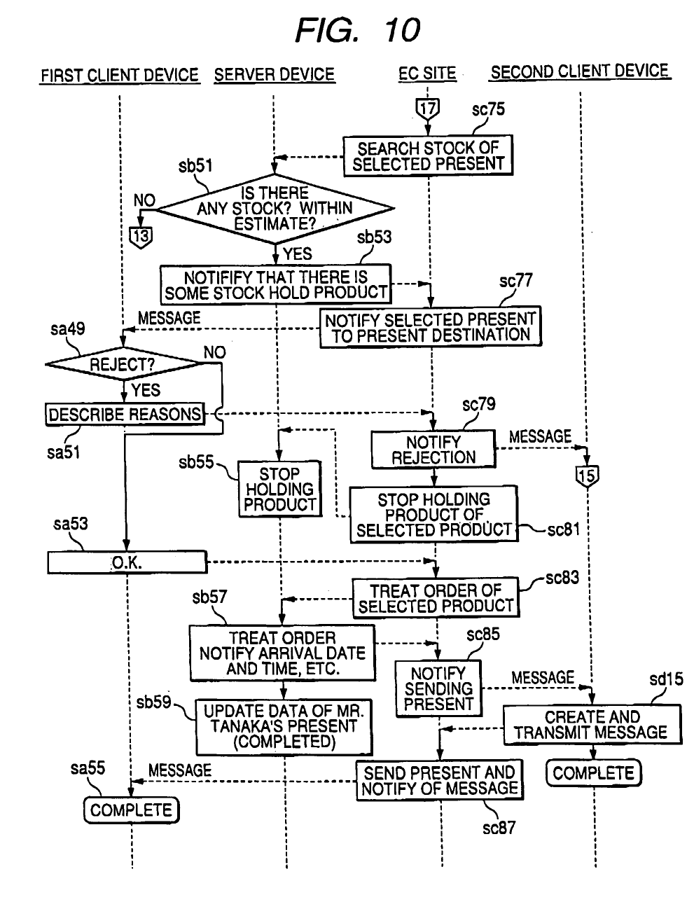

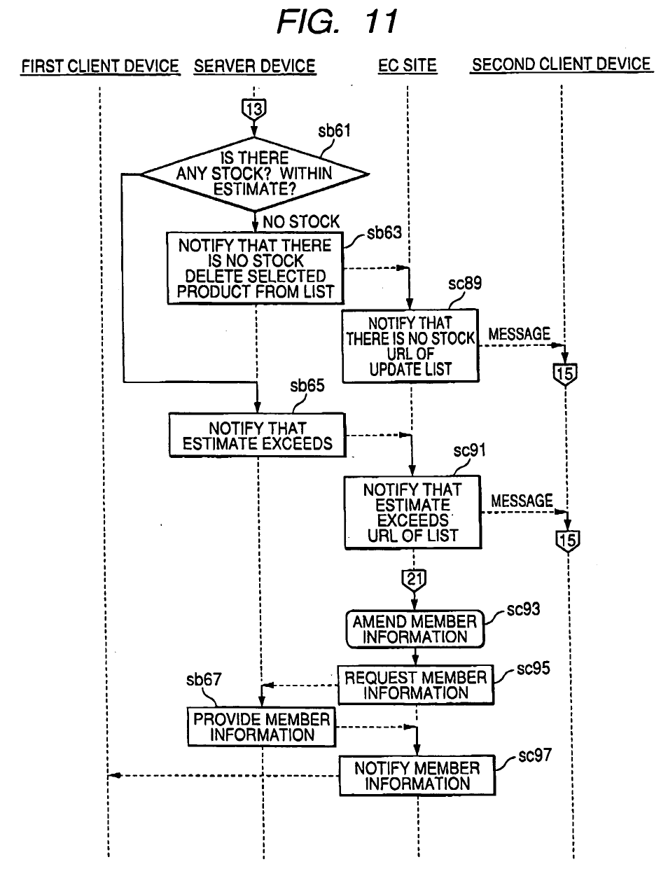

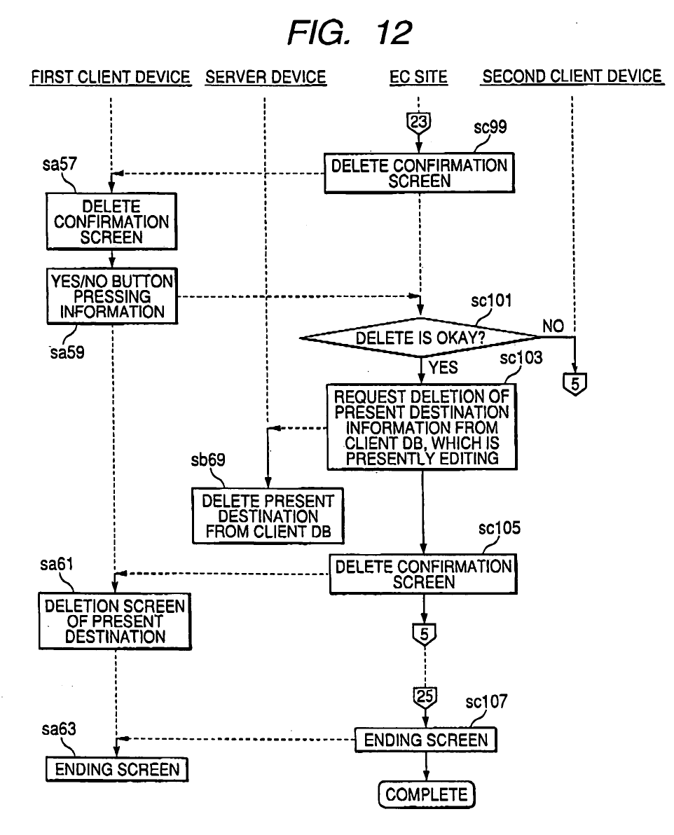

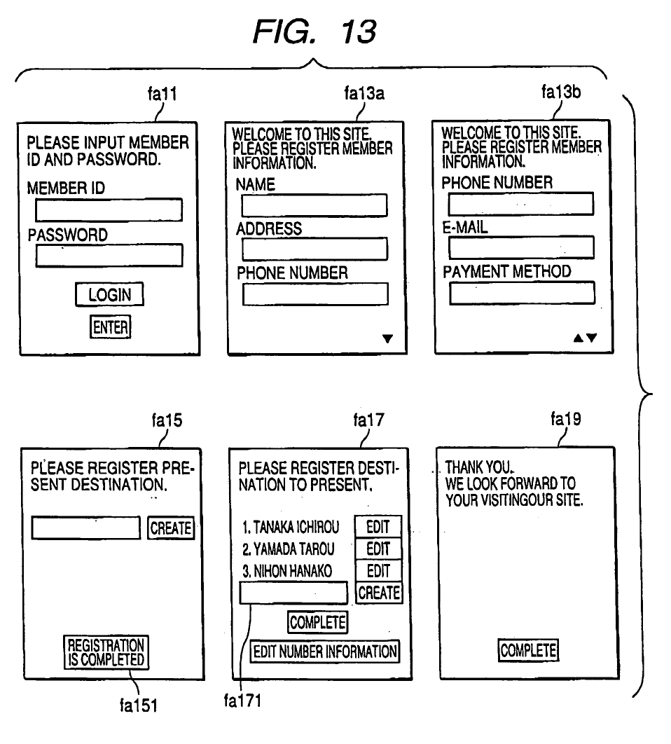

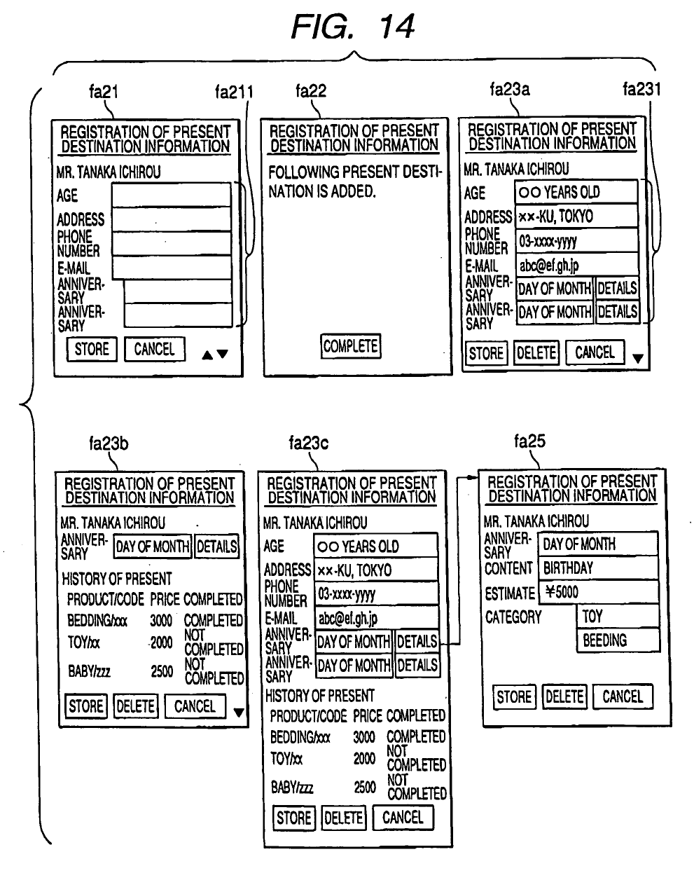

Next, an information processing procedure of the present giving system according to the present invention will be described with reference to the processing sequence and the processing flowcharts shown in FIGS. 4 to 11 and the perusal or display screens of the client device shown in FIGS. 12 to 15. In this embodiment, a user with a client device may be a present sender and also a present receiver in another situation. That is, the client device has various functions necessary for utilization as a present sender and also has various functions necessary for utilization as a present receiver. Herein, in the following description, for the purpose of convenience, it is supposed that one user gives a present to another user, the client device used by the user that is a present sender is denoted as a first client device and the client device used by the user that is a present receiver is denoted by a second client device.

In this embodiment, the client devices carries out the processes of the present invention using a web browser or a mail transmission and reception program installed as a standard feature in the client device, but the client devices may previously download a client application program according to the present invention from the server and may use the downloaded application program.

The first client device accesses the electronic commercial transaction site 15 over Internet 23 using a web browser (sa11) The electronic commercial transaction site 15 transmits screen information requesting input of a member ID and an entrance procedure to the first client device having accessed the site (sc11, fa11).

The first client device displays the received page screen information and receives the input (sa13). The user of the first client device inputs his/her member ID and password and presses a login button, when he/she is a member. When he/she is not a member, the user presses an entrance button for performing a new member registration (sa13).

The first client device determines whether the login button is pressed or the entrance button is pressed (sa15), and transmits the member ID and password to the electronic commercial transaction site 15 when determining that the login button is pressed (sa17). The electronic commercial transaction site 15 transmits the member ID and password to the server device 13 (sc13), and the server device 13 determines through search and retrieval whether the user having accessed the site is registered as a member (sb11).

When the client device is a mobile phone, it is determined from its IP address that it can access through a mobile phone network 24. When the EC site 15 is a formal site registered by a common carrier of the mobile phone network 24, the EC site 15 can acquire user ID information (UID) which is unique identification information given to the user from the mobile phone network 24 at the time of being accessed from the mobile phone 11, so that the EC site may specify the mobile phone (user) by acquiring the UID and the server device 13 may determine whether the user is registered as a member through the retrieval using the UID as a key. In this case, it is not necessary to input the user ID and password of the mobile phone 11.

When it is determined that the user is registered as a member (sb13), the server device edits or processes registered-detail information of a registered present destination in advance (sb15) When it is determined that the user is not registered as a member (sb17), the server device edits or processes the non-membership and transmits the edited details to the electronic commercial transaction site 15 (sb19). The EC site 15 determines as OK or NG the input result of the member ID and password (sc15), and in a case of NG, displays the input screen of the member ID and password again. At this time, the EC site 15 displays a password input error (not shown) and may returns to the input screen for input of the member ID and password. The check of the member ID and password may be carried out by either of the electronic commercial transaction site 15 and the server device 13. In a case of OK, a steps sc27 is performed.

When the first client device determines that the entrance button is pressed, the first client device transmits a new member registration request to the electronic commercial transaction site 15 (sa19). The electronic commercial transaction site 15 transmits to the first client device the screen for inputting an address, a name, a phone number, an electronic mail address, a payment method, payment card information, a bank account, etc. of the user as member information (fig13; sc17, fa13a, fa13b). When the client device is a mobile phone, the screen is small, so that the whole information may not be displayed in one screen. Therefore, although not shown, it is indicated at fa13a and fa13b that the whole screen can be displayed using an up key and a down key of the input keypad 207.

The user of the first client device inputs and transmits his/her own attribute information such as a name, an address, etc. to the electronic commercial transaction site 15 (sa21), the electronic commercial transaction site 15 transmits the member information from the user of the first client device to the server device 13 (sc19), and the server device 13 stores the attribute information of the user in the client information DB 131 (database: hereinafter, referred to as DB) (sb21).

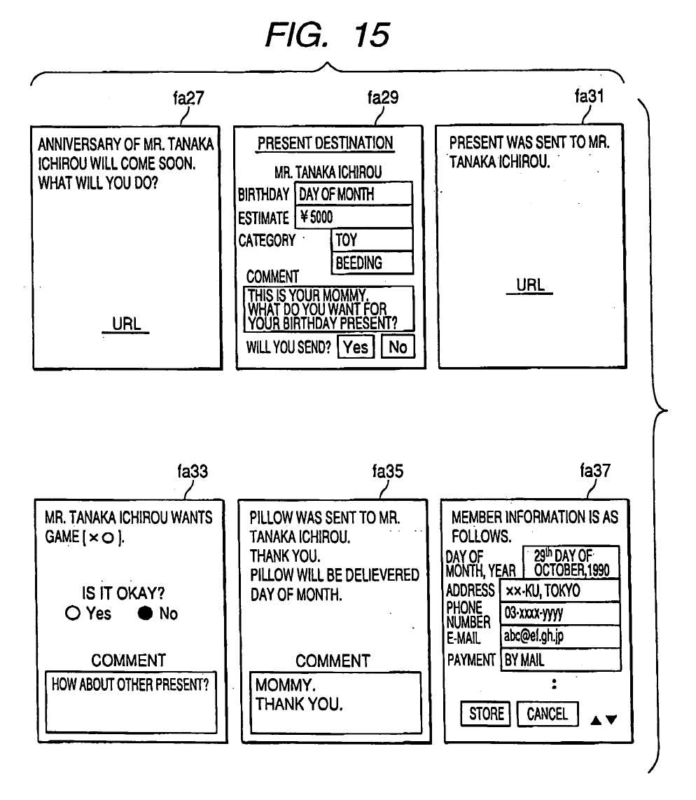

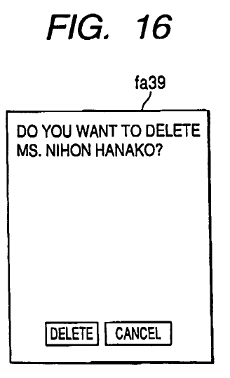

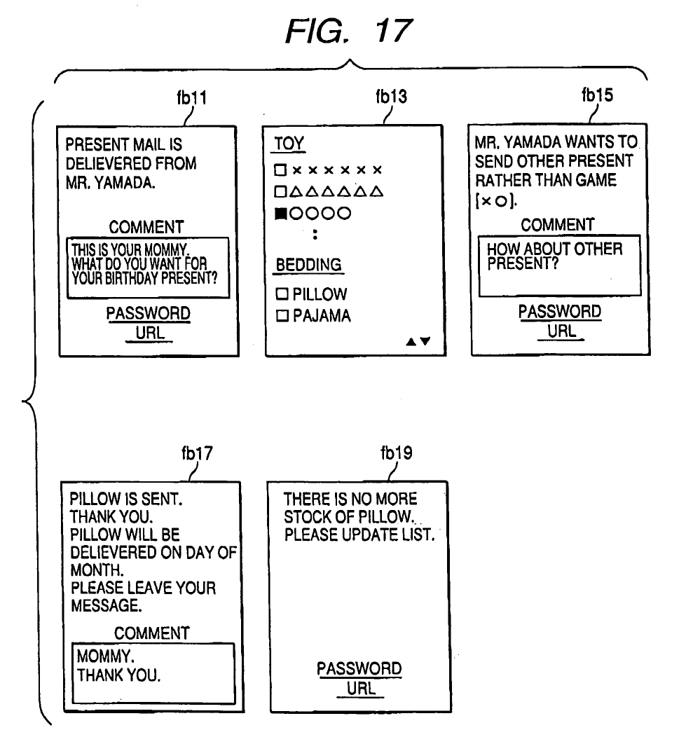

After registration of the member information of the user, the electronic commercial transaction site 15 transmits to the user of the first client device information necessary for transmission such as a name, an age, an address, a phone number, an electronic mail address, etc. of a present receiver as present-destination registration information and a screen for requesting the input of anniversary (FIG. 15; sc21, fa15).

At this time, plural anniversarier can be plurally set, the present plural destinations can be registered. The user of the first client device carries out inputting of the requested necessary information and transmitting the input information to the electronic commercial transaction site 15, or transmits the completion by clearly clicking a registration completion button fa151 (sa23).

In this embodiment, the estimated cost and category of each anniversary of the present destinations are not requested, only a name of the present destination is registered, and detailed setting of the present destinations is carried out through the present-destination screen information displayed when a member accesses the site. The detailed setting of the present destinations may be performed at this step (sa23, fa15).

The electronic commercial transaction site 15 notifies the server device 13 of the present destination information received from the user of the first client device (sc23), and the server device 13 having received the present destination information constantly stores the present destination information in the client information DB 131 of the server device 13 (sb23). Thereafter, the electronic commercial transaction site 15 repeats the processes from the step sc21 until the processing is ended (sc25). The user of the electronic commercial transaction site 15 who becomes a member may store plural-present destination information in the client information DB of the server device 13. The procedure described above corresponds to the input of the present invention.

When accessed by an existing member through input of the member ID and password, the electronic commercial transaction site 15 or the server device 13 transmits a screen of the member information and the present information which can be added to, corrected, and deleted (sc27, fa17). This screen is displayed in the first client device of the user. As a result, the user can additionally prepare, correct, and delete his/her member information and his/her present destination information via the screen, and when the additional preparation, the correction, or the deletion is selected (sa25), the electronic commercial transaction site 15 branches the process in accordance with the information selected by the user (sc29).

When the ending (or completion) is selected, the electronic commercial transaction site prepares an ending screen and transmits the ending screen to the first client device, and the procedure is ended (sc31, sa27, fa19). When the addition of the present destination is selected, the electronic commercial transaction site 15 transmits an additional registration screen of a present destination to the first client device (sc33, sc35, fa21).

The user edits the additional registration screen of a present destination that includes respective items of fa211 (sa29) and then presses a “Store” or “Cancel” button (sa31). The pressed button is checked (sc37), and when it is determined that the “Cancel” button is pressed, the step of displaying an initial screen when the electronic commercial transaction site 15 has been accessed by a member is performed (sc39).

When the “Store” button is pressed, the electronic commercial transaction site 15 requests storage of the additional information to the server device 13 (sc41), and the server device 13 stores the user information, for which the storage has been requested, in the client information DB 131 (sb25). Thereafter, the electronic commercial transaction site 15 notifies the storage of the additional information (sc43), and then the step of displaying an initial screen when the electronic commercial transaction site 15 has been accessed by a member is performed (sc39).

A notification screen indicating that the additional registration is completed is displayed in the first client device of the user (sa33, fa22).

When the user selects the correction of the present information (sc45), the user information is requested from the server device 13 (sc47), and the server device 13 extracts the requested user information from the client information DB 131 (sb27) and transmits the extracted information to the electronic commercial transaction site 15 (sb27). The electronic commercial transaction site 15 transmits a present destination editing screen to the first client device of the user (sc49, fa23a, fa23b, fa23c). Since the whole information cannot be displayed on the screen of the mobile phone, the top screen is indicated by fa23a and the bottom screen is indicated by fa23b. The fa23c indicates a situation that the whole information of a screen is displayed.

The present destination information includes, as shown by fa23a, fa23b, and fa23c, the attribute information such as a name, an address, an age, an electronic mail address, etc. of a present destination, one or more anniversaries, and usage history of the present. The estimated cost, details of the anniversary, and a category of presents, which are set information for the respective anniversaries, can be edited by clicking a “details” button of the anniversary over an initial present destination update screen (fa23c) (fa25). Hereinafter, fa23a, fa23b, and fa23c are intensively expressed as fa23.

When the user edits the respective items of fa231 on the screen of fa23, the user can store the edited details by editing the items (sa35) and pressing the “Store” button. The present destination registration displayed in the screen can be deleted by pressing the “Delete” button. The treatment or operation can be cancelled by pressing the “Cancel” button. The details of each anniversary can be edited by pressing the “Details” button of the corresponding anniversary. The information of “Store”, “Delete”, “Details”, and “Cancel” buttons to be pressed by a user is sent to the electronic commercial transaction site 15 from the first client device (sa37).

The electronic commercial transaction site 15 branches the procedure on the basis of the transmitted button information (sc51). When the button information indicates “Details”, the electronic commercial transaction site 15 requests the information corresponding to the anniversary from the server device 13 (sc55), and the server device 13 searches the client information DB 131 for the information corresponding to the anniversary in the present destination information of the specified user and notifies the electronic commercial transaction site 15 of the searched information (sb29).

The electronic commercial transaction site 15 transmits the notified information to the first client device (sc57, fa25). The user corrects the set information corresponding to the anniversary (sa39) and then presses the “Store” button, or presses the “Delete” button so as to delete the anniversary, or presses the “Cancel” button so as to stop the procedure. The first client device transmits the pressed-button information to the electronic commercial transaction site 15 (sa41). The electronic commercial transaction site 15 branches the procedure in accordance with the pressed-button information (sc59).

In the branch sc59, when the button information indicates “Cancel”, the electronic commercial transaction site 15 displays the screen displaying the present destination information when a member initially logins to the electronic commercial transaction site 15 (sc39). When the button information indicates “Delete”, the electronic commercial transaction site 15 notifies the server device 13 of deletion of the information corresponding to the anniversary of the specified present destination which is specified by the user with respect to the server device 13 (sc61).

The server device 13 having received the notification of deletion deletes the anniversary information of the specified present destination of the specified user (sb31). The electronic commercial transaction site 15 notifies the first client device of the deletion (sc63), and then displays the screen when a member has initially performed the login to the electronic commercial transaction site. When the button information indicates “Store”, the electronic commercial transaction site 15 notifies the sever device 13 of the request of storing the present destination information of the user and the information corresponding to the anniversary (sc65), and displays the screen when a member has initially performed the login to the electronic commercial transaction site. The server device 13 stores the notified information in the client information DB (sb33).

In the initial screen (fa23 and sa35) of a present destination editing screen, when the user selects “Store” (branch at sc51), the user notifies the server device 13 of the request storing the present destination information edited by the user (sc53) and then the step sc41 is performed. In the initial screen (fa23 and sa35) of a present destination editing screen, when the user selects “Cancel”, the initial screen when a member has performed the login to the electronic commercial transaction site is displayed without any process (sc39). When “Delete” is selected at the branch of sc51, the electronic commercial transaction site 15 transmits to the first client device a display screen indicating deletion of the registration of the present destination under display (sc99, fa39). The first client device displays a deletion confirmation screen (sa57, fa39).

When the user of the first client device determines “Yes/No” and presses the “Delete” or “Cancel” button, the pressed-button information is transmitted to the electronic commercial transaction site 15 (sa59). The electronic commercial transaction site 15 checks the pressed-button information (sc101), transmits the request for deleting the present destination information being edited from the client information DB to the server device 13 when the deletion is okay (sc103), notifies the first client device of the deletion of the present destination as a screen display (not shown), and performs the step of displaying the initial screen when a member accesses the electronic commercial transaction site 15 (sc39). The user of the first client device confirms the deletion through the screen display (not shown). The server device 13 having received the deletion request deletes the information of the specified present destination from the client information DB 131.

The server device 13 searches the client information DB 131 of the server device 13 for all the registered members at a predetermined time, for example, once a day (sb37). For example, when data indicating that the anniversary approaches is present, like a case where the anniversary approaches within predetermined number of days (sb39), the server device lists and stores the data, associates the data with the URLs (sb41), and these processes are repeated until the search of all the data regarding the arrival notice data of the anniversary is completed (sb43). The search may be performed, for example, once a month, once every ten days, or once a week, and in this case, anniversaries that closer than the date obtained by adding a predetermined number of days to the next search date are listed.

At this time, the server device simultaneously prepares and stores a list of products within the registered categories and their estimated cost with reference to the product DB 132 and classifies the products into categories. The server device notifies the user of an arrival notice message of an anniversary and the corresponding URL information using an electronic mail or a messaging service with a member ID when a message can be transmitted with the member ID, in accordance with the arrival notice data of the anniversary that has been prepared and stored (sb45, fa27).

When the user having received the arrival notice message of the anniversary accesses the corresponding URL with the first client device (sa45, fa27), the electronic commercial transaction site 15 transmits to the first client device the information indicating the display of the listed and stored data of the user on the screen (sc67, fa29). The user can correct the set information such as the estimated cost, the category previously set by the user with reference to the present destination information of the anniversary registered by the user, and can determine whether the present should be given. When it is determined that the present should be given, the user writes a message to be sent to the present receiver in a comment column (fa29) with or without correction of the estimated cost, the category, etc., and by clicking the “Yes” button, the first client device transmits the information to the electronic commercial transaction site 15 (sa47).

When it is determined that the present should not be given, the first client device notifies the electronic commercial transaction site 15 of no presentation, by clicking the “No” button. The electronic commercial transaction site 15 checks the received button information (sc68), transmits the ending screen in a case of “No presentation”, and performs the step of displaying the initial screen when a member accesses the electronic commercial transaction site 15. At this time, when the user of the first client device sees the ending screen (sa63), the user peruses the registered-again present destination information screen. The procedure described above corresponds to the preliminary notifier of the present invention.

When the estimated cost or category has been modified, the electronic commercial transaction site 15 again requests the listing of products within a category corresponding to the estimated cost by the server device 13 (sc69), and the server device 13 lists products corresponding to the category and the estimated cost from the product DB 132 classified into categories, sets the access restriction to the listed data, and notifies the second client device as a present receiver of a URL, a password for accessing the URL, and a message prepared (sb47) by the present sender using an electronic mail or a messaging service sending a message with a member ID (sb47, fb11).

The user of the second client device having received the present message accesses the URL included in the received message (sd11). At this time, since the input of a password is requested, the user inputs the received password (sd11). In a case of a wrong password, the user cannot access the URL and the input of the password is requested again (sd11). In a case of a correct password, the user of the second client device can see the message input by the user of the first client and notified by the electronic commercial transaction site 15 and the information of the product list corresponding to the category within the estimated cost (sc73, fb13). The procedure described above corresponds to the notifier of the present invention.

Next, the user of the second client device selects the listed products with a click, etc. and notifies the electronic commercial transaction site 15 of the selected product (sd13). At this time, plural products can be selected within the estimated cost. The electronic commercial transaction site 15 having received the selected product information notifies the server device 13 of the selected product (sc75). In this embodiment, although it has been exemplified that plural products are selected at a time, the selected product may be informed to the electronic commercial transaction site 15 every time one product is selected. Although not shown, when the plural products are selected at a time, the remaining amount of money may be displayed every time a product is selected with an application program of a mobile phone. It may be checked with the application program of the mobile phone whether the amount of money is exceeded and when the amount of money is exceeded, a process of displaying an error may take place.

In this embodiment, the server device 13 calculates the total cost for the selected products, compares the total cost with the registered estimated cost, and determines whether the total cost exceeds the estimated cost. When it is determined that the total cost is within the estimated cost, the server device 13 determines whether the product is in stock (sb51). When it is determined that there is a stock of the product within the estimated cost, the server device provisionally holds the corresponding product (sb53) and notifies the electronic commercial transaction site 15 that there is no problem regarding the product selected by the present destination (sb53).

The electronic commercial transaction site 15 notifies the user of the first client device of the list of products selected by the user of the second client device as a present receiver that are within the estimated cost and in stock, using an electronic mail (sc77, fa29). The user of the first client device as the present sender can reject the product selected by the present receiver (sa49).

When the user of the first client device as the present sender rejects the product, the input of a message such as reasons for the rejection, etc. is requested and the input message and the rejection is notified or informed to the electronic commercial transaction site 15 (sa51).

The electronic commercial transaction site 15 prepares the message from the user of the first client device as the present sender and the product list from which the rejected product is deleted, and notifies the user of the second client device of the prepared message and product list together with the URL of the product list and the password as a message (sc79, fb15). In order to stop the provisional hold of the rejected product, the provisional hold stop is requested to the server device 13 (sc81), and the server device 13 stops the provisional hold of the rejected product (sb55). The procedure described above corresponds to the acceptance-rejection determiner of the present invention.

When the user of the first client device as the present sender does not reject the product selected by the user of the second client device, the first client device notifies the electronic commercial transaction site 15 that there is no problem (sa53), and the electronic commercial transaction site 15 instructs the server device 13 to perform the order processing (i.e., ordering) through notification (sc83).

The server device 13 performs the order processing (i.e. ordering) and the estimation of an arrival date is performed to notify the electronic commercial transaction site 15 (sb57), and then performs the control of changing the present destination information of the user of the first client device to “order completion” from “not-ordered” (sb59).

The electronic commercial transaction site 15 notifies the user of the second client device as the present receiver of the presentation, the estimated arrival date, and the message of requesting the input of a message to be sent to the present sender (sc85, fb17). When the electronic commercial transaction site 15 receives the reception notification including the message from the user of the second client device (sd15), the electronic commercial transaction site 15 notifies the user of the first client device of the notice of sending present, the message from the user of the second client device and the estimated arriving date of the present (sc87), and the user of the first client device confirms the message (sa55, fa31) and the present order process is completed.

When the estimated cost is exceeded at (sb61), the excess of the estimated cost is notified to the electronic commercial transaction site 15 (sb65), and the electronic commercial transaction site 15 transmits the message indicating the excess of the estimated cost and the message indicating modification of the URL to the user of the second client device (sc91).

When the estimated cost is not exceeded but there is no stock, “no stock” is notified to the electronic commercial transaction site 15 (sb63). The electronic commercial transaction site 15 transmits a message of “no stock” and a list from which the product having no stock is deleted, together with the URL and a password to the user of the second client device (sc89), thereby attracting the user of the second client device to the URL screen.

When the member information is corrected at the step sc29 (sc93), the electronic commercial transaction site 15 requests the member information of the user of the first client device from the server device 13 (sc95), and the server device 13 searches the client information DB for the corresponding user information and notifies the electronic commercial transaction site 15 of the searched information (sb67). Then, the electronic commercial transaction site 15 notifies the user of the first client device having inquired his/her information of the searched information (sc97). After that, the user can correct the set information.

In this embodiment, the electronic commercial transaction site 15 and the server device 13 are provided separately, but they may be provided as one body. In this case, in the processing sequence and the flowchart shown in FIG. 4, the communication between the electronic commercial transaction site 15 and the server device 13 is embodied or carried out as an internal procedure.

As can be seen form the above description, the following advantages can be obtained according to this described embodiment of the present invention.

(1) In the electronic commercial transaction of the present giving system, the present sender can to send a present without fail, the present sender can give a right of selecting a product for present to the present receiver, and the present sender can have a right of determining the acceptance and rejection thereof.

(2) Since the estimated cost of present and the category can be set by the present sender, a present within the estimated cost and the category can be sent.

(3) Since an electronic mail address or an account name unique to a member of the present giving system can be used at the time of notification of a message, the present giving process can be more promptly performed than in a case of using a mail service, so that it is possible to specify individuals without any human error.

(4) Since plural presents can be selected within the estimated cost of products, the range within which the second client, to receive the presents can select the presents is broadened, so that the service quality is improved.

(5) Since the proper date and time before the input date can be specified by the present sender, it is possible to cope with delicate needs of the client to send a present.

(6) Since the present sender can transmit a message to the present receiver, the present invention is user-friendly.

(7) By utilizing an URL as means for informing details of presents, setting the access restriction to perusal of the URL notified through mails, etc., and notifying the second client device of a message including a removal key of the access restriction, the present selecting screen can be displayed by one click on the message receiving screen, and since the access restriction is set, it is possible to securely utilize the present invention.

(8) When the present sender rejects the item selected by the present receiver, the rejected item can be automatically deleted from the list, the remaining items can be notified to the present receiver again, and when the present receiver does not reject the remaining items, the present receiver can send a message to the present sender, so that the convenience is improved.

The present invention is applicable to communication and computer industries including electronic commercial transaction systems, server devices, electronic commercial transaction programs, etc. provided through communication networks.

According to the present invention, a present sender can send a present without fail, the present sender can give a present receiver a right of selecting a product for the present, and the present sender can also have a right of determining the acceptance and rejection of the selected present. Therefore, it is possible to provide a present giving service satisfying requirements from both of the present sender and the present receiver, so that it is possible to improve a degree of satisfaction of users.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention extends to all functionally equivalent structures, methods and uses, such as are within the scope of the appended claims.

1. A present giving system comprising:
first and second client devices which are used by users and can communicate with a server system through networks; and
the server system capable of communicating with the first and second client devices through the networks, the server system including: an input for receiving and storing information of a date related to a user, information uniquely specifying a user of the second client device, and information of selection items associated with the date information from the first client device; a preliminary notifier for notifying the first client device of an approach of the date and details of the selection items associated with the date information at a predetermined notice date and time before the input date; a notifier means for notifying the second client device of present candidates based on the selection items transmitted from the first client device based on the notice; and acceptance-rejection determiner means for notifying the first client device of information of a selected present transmitted from the second client device and allowing the first client device to accept or reject the present selected by the second client device.

2. A present giving server system capable of communicating with first and second client devices used by users through networks, the server system comprising:
an input means for receiving and storing information of a date related a user, information uniquely specifying a user of the second client device, and information of selection items associated with the date information from the first client device;
a preliminary notifier means for notifying the first client device of an approach of the date and details of the selection items associated with the date information at a predetermined notice date and time before the input date;
a notifier for notifying the second client device of present candidates based on the selection items transmitted from the first client device based on the notice; and
an acceptance-rejection determiner for notifying the first client device of information of a selected present transmitted from the second client device and allowing the first client device to accept or reject the present selected by the second client device.

3. The present giving server system according to claim 2, wherein the date information is an anniversary of a present recipient, and the selection items associated with the date information includes an estimated cost for a product to be presented and a category of presents.

4. The present giving server system according to claim 2, wherein the information uniquely specifying a user of the second client device is an electronic mail address.

5. The present giving server system according to claim 2, wherein the information uniquely specifying a user of the second client device is an account name unique to a member of a present giving system, and a message can be electronically transmitted and in association with the account name.

6. The present giving server system according to claim 2, wherein plural presents can be selected within the estimated cost.

7. The present giving server system according to claim 2, wherein the notice date and time can be set by the first client device.

8. The present giving server system according to claim 2, wherein the first client device can input a message about the user of the second client device on the basis of the notification from the preliminary notifier, and the notifier notifies the second client device of the message input by the first client device

9. The present giving server system according to claim 2, wherein the notifier uses an URL as a pointer indicating a source of the information associated with the present candidates, sets an access restriction to the reading of the notified URL, and notifies the second client device of a message including a removal key of the access restriction.

10. The present giving server system according to claim 2, wherein when the selected present information transmitted from the second client device is rejected by the first client device, the acceptance-rejection determiner deletes the rejected present from the present candidates and allows the notifier to again notify the second client device of the remaining present candidates.

11. The present giving server system according to claim 2, wherein the acceptance-rejection determiner enables the first client device to input a message about the user of the second client device, and the notifier notifies the second client device the message input by the first client device.

12. A present giving program allowing a computer of a server system, which can communicate with first and second client devices used by users through networks, to have functions of:
an input for receiving and storing information of a date related to a user, information uniquely specifying a user of the second client device, and information of selection items associated with the date information from the first client device;
a preliminary notifier for notifying the first client device of an approach of the date and details of the selection items associated with the date information at a predetermined notice date and time before the input date;
a notifier for notifying the second client device of present candidates based on the selection items transmitted from the first client device based on the notice; and
an acceptance-rejection determiner for notifying the first client device of information of a selected present transmitted from the second client device and allowing the first client device to accept or reject the present selected by the second client device.

13. A present giving method, comprising the steps of:
inputting, by a first client device information of a date related to a user, information uniquely specifying a user of a second client device, and information of selection items associated with the date information to a server system and storing the input information in the server system;
notifying, by allowing the server system, the first client device of an approach of the date and details of the selection items associated with the date information at a predetermined notice date and time before the input date;
notifying, by the server system, the second client device of present candidates based on the selection items transmitted from the first client device based on the notice; and
notifying, by the server system, the first client device of information of a selected present transmitted from the second client device and allowing the first client device to accept or reject the present selected by the second client device.
